(19) United States
(12) Patent Application Publication
(10) Pub. No.: US 2020/0139573 A1
(43) Pub. Date: May 7, 2020

(54) WOODTURNING TOOL

(71) Applicant: Woodpeckers, LLC, Strongsville, OH (US)

(72) Inventors: Jeffery E. Farris, Medina, OH (US); Alex Krupa, Parma Heights, OH (US); Richard M. Hummel, Parma, OH (US)

(21) Appl. No.: 16/670,425

(22) Filed: Oct. 31, 2019

Related U.S. Application Data
(63) Continuation-in-part of application No. 16/179,108, filed on Nov. 2, 2018, now Pat. No. 10,493,651.

(51) Int. Cl. B27C 7/06; B27G 15/00; B25D 3/00; B27C 7/04

(52) U.S. Cl. CPC B27C 7/06; B27C 7/04; B25D 3/00; B27G 15/00

(57) ABSTRACT

A tool, system, and method for shaping a wooden workpiece. The system includes a lathe, a toolrest, and a woodturning tool for removing material from the workpiece. The tool includes a handle with a shaft extending longitudinally outwardly therefrom. A cutter is provided on an end of the shaft. The shaft includes a longitudinally-extending bottom surface and a longitudinally-extending side surface. The side surface extends laterally outwardly from the bottom surface and at an obtuse angle relative thereto. Two contact points provided on one of the bottom and side surfaces are brought into contact with the toolrest on the lathe to steady the shaft and use the cutter on the workpiece. The orientation of the cutter is changed between a first position and second position depending on which of the bottom surface or side surface contacts the toolrest.

### CROSS-REFERENCE TO RELATED APPLICATION

This is a Continuation-in-Part of U.S. patent application Ser. No. 16/179,108 filed Nov. 2, 2018, the entire specification of which is incorporated herein by reference.

### TECHNICAL FIELD

The present disclosure relates to a woodworking tool. More particularly, the disclosure is directed to a woodturning tool. Specifically, the disclosure relates to a woodturning tool having a shaft with three longitudinally-extending and adjacent surfaces, wherein the surfaces include a bottom surface that is flanked by left and right side surfaces that are each oriented to the bottom surface at an obtuse angle. The shaft is rotated to selectively position two spaced-apart contact points or a flat region of one of these three surfaces on a toolrest on a lathe and to thereby select an orientation of a cutter at the end of the shaft relative to a wooden workpiece mounted on the lathe.

### BACKGROUND

### Background Information

Woodturning relates to the production of a wooden object on a lathe. A block of wood (or workpiece) is secured to the lathe and the lathe will rotate the workpiece about an axis of rotation. A wide variety of different hand-held woodturning tools have been developed to scrape and shave wood from a rotating workpiece in order to form a desired end product.

Typically, a woodturning tool will include a handle that has a steel shaft extending outwardly therefrom. A cutter will be provided at the end of the shaft. A craftsman will rest the shaft of the woodturning tool on a toolrest provided on the lathe and will bring the cutter at the tip of the woodturning tool into contact with the rotating workpiece. The cutter will tend to scrape or shave wood off the workpiece as the workpiece is rotated. The particular shape of the cutter will form a particular profile in the wood. The craftsman will adjust the angle of the shaft, and thereby of the cutter, and will vary the pressure of contact of the cutter with the rotating workpiece in order to form the desired shape of the end product.

Craftsmen will typically use a number of different woodturning tools while producing an end product. Each of the different tools will perform a different function. Over the past several years woodturning tools that utilize replaceable carbide inserts as cutters have become popular. The carbide inserts may have a round shape, a square shape, or a diamond shape, for example. Round shaped cutters may be utilized in tasks such as hollowing out the interior of a bowl, for example. If the woodturning tool, and thereby the round cutter is not held and manipulated in the correct fashion, then the hollowing process may not produce an aesthetically pleasing finish on the interior of a bowl, for example.

Some tool makers, such as Carter Products Company, Inc. of Grand Rapids, Mich., sell a round cutter woodturning tool that utilizes replaceable round carbide tips and has a flat region machined into the shaft of the woodturning tool. The flat region forms a back surface of the tool. During use, the craftsman will place the flat back surface onto the toolrest and this arrangement helps the craftsman to correctly position the cutter at a correct angle square onto the workpiece. However, hollowing workpieces with a cutter, it can be difficult to form a smooth interior surface on the hollowed region of the workpiece. This is because the shaft of the tool needs to be rotated to some degree during the cutting process. The rotation of the shaft can be reasonably difficult to perform in a fluid manner when trying to rotate a shaft that has a flat back surface into a different position. The shaft may therefore be provided with a radiused corners on either side of the flat region, i.e., the surfaces of the shaft immediately adjacent the longitudinal edges of the flat region are rounded.

### SUMMARY

A tool, system, and method for shaping a wooden workpiece in accordance with the present disclosure are disclosed herein. The system includes a lathe, a toolrest, and a woodturning tool for removing material from the workpiece. The tool includes a handle with a shaft extending longitudinally outwardly therefrom. A cutter is provided on an end of the shaft. The shaft includes a longitudinally-extending bottom surface and a longitudinally-extending side surface. The side surface extends laterally outwardly from the bottom surface and at an obtuse angle relative thereto. Two contact points provided on one of the bottom and side surfaces are brought into contact with the toolrest on the lathe to steady the shaft and use the cutter on the workpiece. The orientation of the cutter is changed between a first position and second position depending on which of the bottom surface or side surface contacts the toolrest.

In one aspect, the present disclosure may provide a wordturning tool comprising a handle; a shaft extending outwardly from the handle, said shaft having a longitudinal axis; and a cutter provided on an end of the shaft a distance away from the handle; wherein the shaft includes a bottom surface and a side surface extending outwardly from the bottom surface and at an obtuse angle relative thereto; wherein each of the bottom surface and the side surface is flat and is adapted to be separately brought into contact with a toolrest on a lathe.

In another aspect, the present disclosure may provide a wordturning tool comprising a handle; a shaft extending outwardly from the handle, said shaft having a longitudinal axis; and a cutter provided on an end of the shaft a distance away from the handle; wherein the shaft includes a region having an exterior surface oriented at right angles to the longitudinal axis; wherein the exterior surface is adapted to be brought into contact with a top surface of a toolrest on a lathe; and wherein the region is a truncated-triangle in shape. The exterior surface includes a bottom surface, a left side surface extending outwardly from the bottom surface in a first direction, and a right side surface extending outwardly from the bottom surface in a second direction; wherein each of the left side surface and the right side surface is oriented at an obtuse angle relative to the bottom surface. The obtuse angle is about 135° each of the bottom surface, the left side surface, and the right side surface is flat.

In another aspect, the present disclosure may provide a system for shaping a workpiece comprising a lathe including a chuck adapted to retain a workpiece thereon; a toolrest provided on the lathe; and a woodturning tool adapted to remove material from the workpiece, wherein said woodturning tool comprises a handle; a shaft extending outwardly from the handle, said shaft having a longitudinal axis; and a cutter provided on an end of the shaft a distance away from the handle; wherein the shaft includes a bottom surface and a side surface that extend longitudinally along the shaft; and wherein the side surface extends laterally from the bottom surface and at an obtuse angle relative thereto; wherein the bottom surface and side surface are selectively brought into contact with a surface of the toolrest. The bottom surface and side surface form part of an exterior surface of the shaft. The side surface is a left side surface that extends outwardly from the bottom surface in a first direction; and the exterior surface of the shaft further includes a right side surface that extends outwardly from the bottom surface in a second direction and at a same obtuse angle relative to the bottom surface. The obtuse angle is about 135°. The shaft is a five-sided polygon in cross-section and includes five longitudinally extending surfaces that form an exterior surface of the shaft; and wherein the bottom surface and side surface comprise two sides of the five-sided polygon. Each of the bottom surface, the left side surface, and the right side surface is flat. The top surface of the toolrest is also flat.

In another aspect, the present disclosure may provide a method of shaping a wooden workpiece comprising securing a wooden workpiece to a rotatable member of a lathe; rotating the rotatable member about an axis; resting a bottom surface of a shaft of a woodturning tool on a top surface of a toolrest on the lathe, where the bottom surface is flat; bringing a cutter on the end of the shaft into contact with the wooden workpiece; removing wood from the wooden workpiece with the cutter, when the cutter is located in a first orientation; rotating the shaft of the woodturning tool to bring a side surface of the shaft into contact with the top surface of the toolrest, wherein side surface is flat and is oriented at an obtuse angle relative to the bottom surface; and removing wood from the wooden workpiece with the cutter, when the cutter is located in a second orientation. The step of removing of wood with the cutter when the cutter is in the first orientation includes producing a rough-cut surface in the workpiece. The step of removing of wood with the cutter when the cutter is in the second orientation includes producing a finished surface in the workpiece. The step of producing of the finished surface includes producing the finished surface with the cutter and without requiring additional sanding to produce the finished surface.

In one aspect, the present disclosure may provide a woodturning tool comprising a handle; a shaft extending outwardly from the handle, said shaft having a longitudinal axis; and a cutter provided on an end of the shaft a distance away from the handle; wherein the shaft includes a bottom surface; a side surface extending laterally outwardly from the bottom surface; a top surface extending laterally outwardly from the side surface; and wherein one or more of the bottom surface, the side surface, and the top surface presents two contact points for contacting a toolrest on a lathe.

In one aspect, the present disclosure may provide a system for shaping a workpiece comprising a lathe including a chuck adapted to retain a workpiece thereon; a toolrest provided on the lathe; and a woodturning tool adapted to remove material from the workpiece, wherein said woodturning tool comprises a handle; a shaft extending outwardly from the handle, said shaft having a longitudinal axis; and a cutter provided on an end of the shaft a distance away from the handle; wherein the shaft includes adjacent surfaces that extend longitudinally along the shaft from proximate the handle to proximate the end of the shaft that includes the cutter; and wherein two contact points presented by one of the adjacent surfaces are selectively brought into contact with a surface of the toolrest when the woodturning tool is utilized during a woodturning operation.

In one aspect, the present disclosure may provide a method of shaping a wooden workpiece comprising securing a wooden workpiece to a rotatable member of a lathe; rotating the rotatable member about an axis; providing a woodturning tool having a handle and a shaft; where the shaft includes adjacent surfaces extending from proximate the handle to proximate an end of the shaft; orienting a cutter on the end of the shaft in a first orientation by selectively resting two spaced-apart contact points on one of the adjacent surfaces on a top surface of a toolrest on the lathe; bringing the cutter into contact with the wooden workpiece; and removing wood from the wooden workpiece with the cutter, when the cutter is in the first orientation. The method further comprises rotating the shaft of the woodturning tool to position the cutter in a second orientation by placing another of the adjacent surfaces of the shaft in contact with the top surface of the toolrest; and removing wood from the wooden workpiece with the cutter, when the cutter is located in a second orientation. The removing of wood with the cutter when the cutter is in the first orientation includes producing a rough-cut surface in the workpiece. The removing of wood with the cutter when the cutter is in the second orientation includes producing a finished surface in the workpiece with the cutter and without requiring additional sanding to produce the finished surface.

### BRIEF DESCRIPTION OF THE SEVERAL VIEWS OF THE DRAWINGS

A sample embodiment of the disclosure is set forth in the following description, is shown in the drawings and is particularly and distinctly pointed out and set forth in the appended claims. The accompanying drawings, which are fully incorporated herein and constitute a part of the specification, illustrate various examples, methods, and other example embodiments of various aspects of the disclosure. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 is a partial top plan view of a woodturning tool in accordance with an aspect of the present disclosure, with the tool shown in a first position where the tool is being used to remove wood from a workpiece that is rotatably secured to a chuck of a lathe;

FIG. 2 is an isometric perspective top view of the woodturning tool shown on its own;

FIG. 3 is an isometric perspective bottom view of the woodturning tool shown on its own;

FIG. 4 is a partial bottom plan view of the woodturning tool;

FIG. 5 is a partial cross-sectional view of the woodturning tool in the first position and shown in contact with the toolrest of the lathe, where the figure is taken along line 5-5 of FIG. 1;

FIG. 6 partial top plan view of the woodturning tool in accordance shown in a second position where the tool is being used to remove wood from the workpiece that is rotatably secured to the chuck of the lathe; and

FIG. 7 is a partial cross-sectional view of the woodturning tool in the second position and shown in contact with the toolrest of the lathe, where the figure is taken along line 7-7 of FIG. 6;

FIG. 8 is a partial cross-sectional view of the woodturning tool in a third position that is a mirror image of the second position shown in FIG. 7 and shows the tool in contact with the toolrest of the lathe when in the third position;

FIG. 9 is a partial cross-sectional view of the woodturning tool showing the region of the shaft that includes exterior surface is of a truncated-triangular shape and includes a left side surface, a bottom surface, a right side surface, and an imaginary line that extends from one apex to another; plus an additional region shown in phantom; and

FIG. 10 is a partial cross-sectional view of a second embodiment of the shaft of the woodturning tool in accordance with the present disclosure, where the cross-section of the shaft of the woodturning tool is taken in a similar position to line 7-7 of FIG. 6, and showing the shaft in a second position in contact with the toolrest of the lathe.

Similar numbers refer to similar parts throughout the drawings.

### DETAILED DESCRIPTION

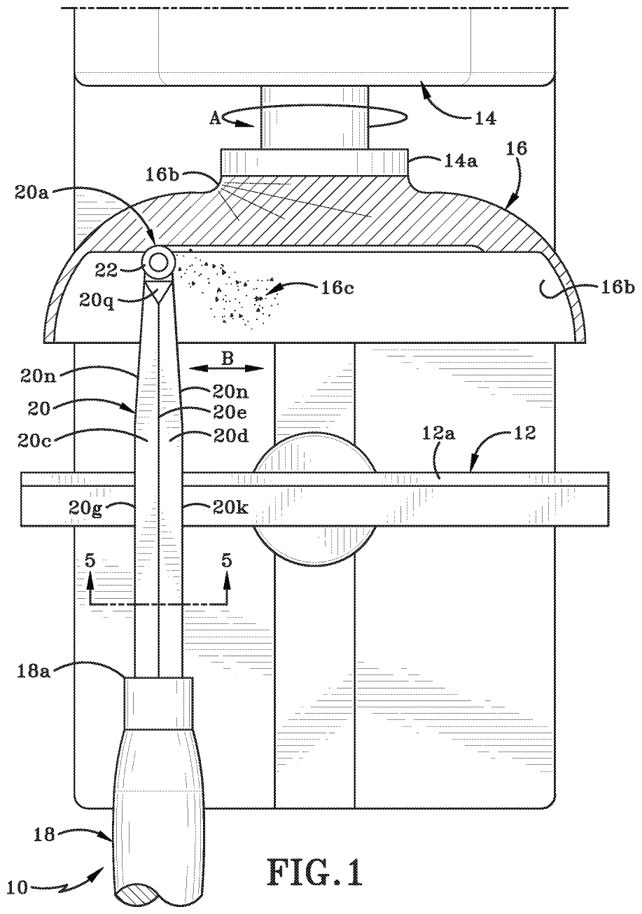

Referring to FIGS. 1-9, there is shown a woodturning tool in accordance with the present disclosure, generally indicated at 10. Tool 10 is shown in a first position in FIG. 1 resting on a portion of a toolrest 12 of a lathe, where a portion of the lathe is illustrated in the figure and is indicated by the reference number 14. Tool 10 is being utilized to remove wood from a workpiece 16. In particular, tool 10 is being utilized to hollow out an interior cavity 16a of a bowl (i.e., the workpiece 16). Workpiece 16 is attached to a chuck 14a of lathe 14 by way of a tenon 16b extending outwardly from a bottom end of workpiece 16. The chuck 14a is rotated, as indicated by arrow “A”. FIG. 1 also shows tool 10 being moved in the direction of arrow “B” and wood shavings 16c being removed from workpiece 16.

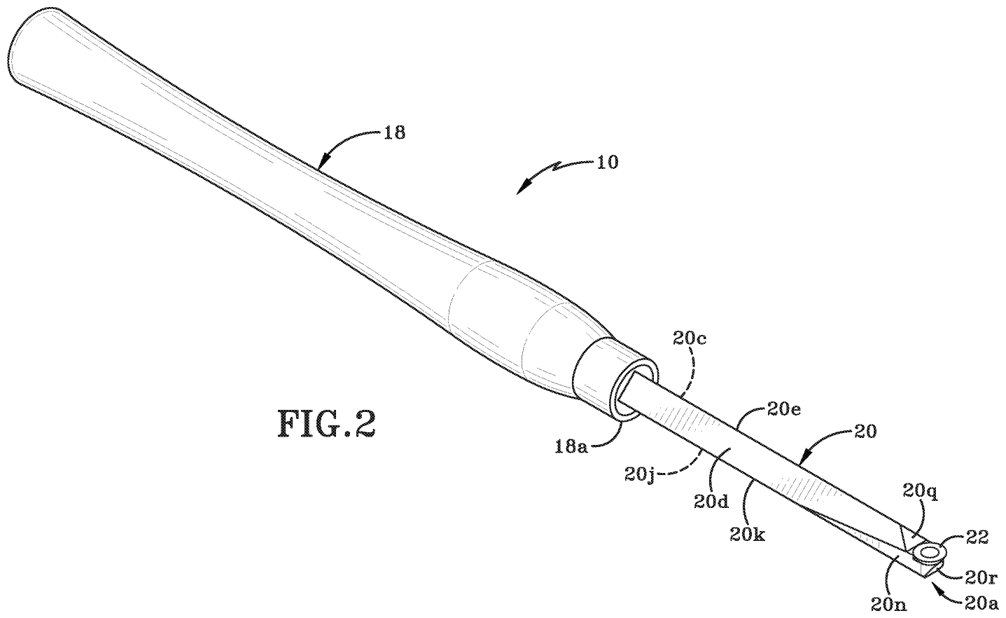

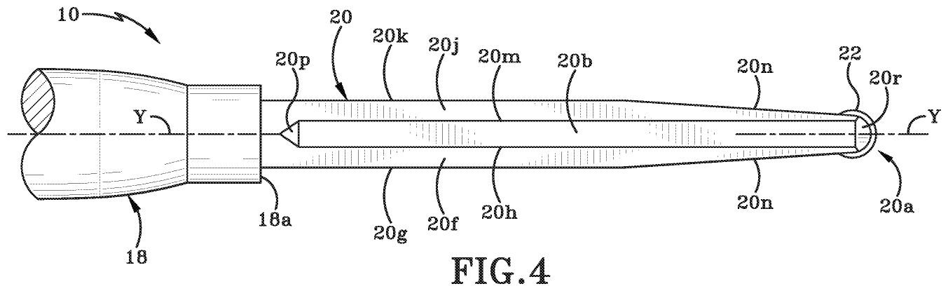

FIGS. 2-4 show tool 10 in greater detail. Tool 10 includes a handle 18 that may be fabricated of wood or any other suitable material. Handle 18 may be ergonomically shaped and may be of any desired length and cross-sectional shape. A shaft 20 extends outwardly from a first end 18a of handle 18. Shaft 20 may have a first end 20a that is located a distance outwardly beyond first end 18a of handle 18. Shaft 20 may have a second end that is embedded some distance within an interior bore of handle 18. Tool 10 has a longitudinal axis “Y” (FIG. 4) that extends from first end 18a of handle 18 to first end 20a of shaft 20. The specific configuration of shaft 20 is the focus of this disclosure and will be discussed later herein.

A cutter 22 is provided at first end 20a of shaft 20. Cutter 22 may comprise a carbide insert that is detachably secured to first end 20a. The particular cutter 22 shown in the attached figures is a round cutter. It will be understood, however, that the cutter 22 may be of a different shape from what is illustrated herein. For example, the cutter 22 may be of a square shape, or a diamond shape, or a square shape with rounded corners, or any other shape. Cutter 22 may be secured to shaft 20 by way of a fastener. The round cutter 22 is particularly useful for hollowing out cavities in workpieces 16. Other shaped cutters that may be engaged with shaft 20 may be utilized in other woodturning processes.

In other instances, the cutter 22 may be formed integral with shaft 20 and may be shaped in any manner that permits the craftsman to shape workpiece 16 through removal of wood therefrom. In other words, the cutter or the first end of shaft 20 may be configured to perform any of typical cutting actions of other wood turning tools such as parting tools, spear scrapers, skew chisels, round nose scrapers, bowl gouges, spindle gouges, roughing gouges, nose scrapers, etc.

Shaft 20 may be fabricated from any suitable material, such as steel, for example. Shaft 20 is fabricated so that substantially the entire length thereof has a cross-section that is configured as a five-sided polygon. Firstly, shaft 20 may be fabricate to have a bottom surface 20b that is flat and extends from a region proximate first end 18a of handle 18 to a region proximate first end 20a of shaft 20. Bottom surface 20b is provided so that shaft 20 may be rested in a first position (i.e., first orientation) upon at least a top surface 12a of toolrest 12. The flat bottom surface 20b helps the craftsman to hold first end 20a and cutter 22 in a stable position relative to workpiece 16.

Shaft 20 further comprises a left top surface 20c and a right top surface 20d. Left and right top surfaces 20c, 20d extend longitudinally from first end 18a of handle 18 towards first end 20a of shaft 20. Left and right top surfaces 20c, 20d meet along a longitudinally-extending apex 20e. Left and right top surfaces 20c, 20d may be oriented at angle of about 90° relative to each other.

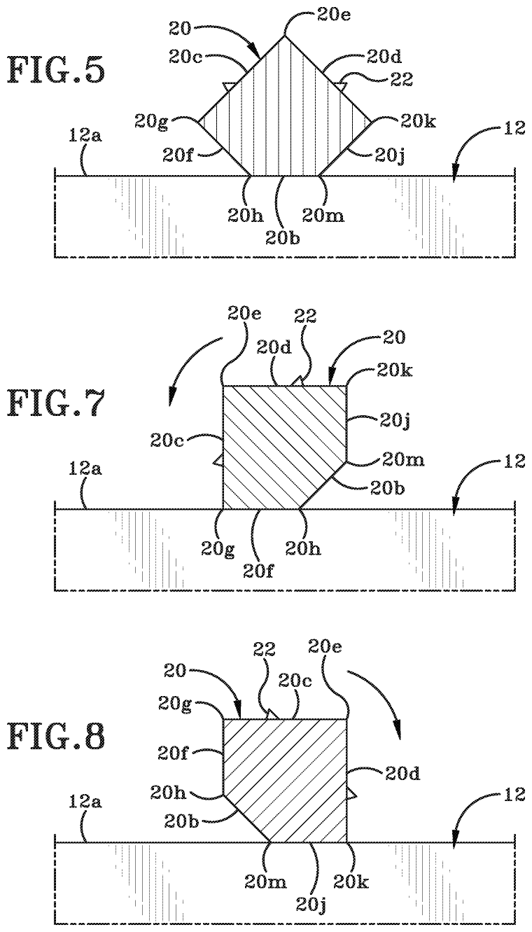

Shaft 20 further comprises a left side surface 20f that originates proximate first end 18a and terminates proximate first end 20a and is located between left top surface 20c and bottom surface 20b. Left side surface 20f meets left top surface 20c along a longitudinally-extending apex 20g (FIG. 5) and meets bottom surface 20b along a longitudinally-extending apex 20h. Left side surface 20f may be oriented at an angle of about 90° relative to left top surface 20c. Left side surface 20f may be oriented at an angle of about 135° relative to bottom surface 20b.

Shaft 20 further comprises a right side surface 20j that originates proximate first end 18a and terminates proximate first end 20a and is located between right top surface 20d and bottom surface 20b. (Bottom surface 20b originates a distance inwardly from the first end 18a of handle 18 and terminates a distance inwardly from the cutter 22.

Right side surface 20j meets right top surface 20d along a longitudinally-extending apex 20k (FIG. 5) and meets bottom surface 20b along a longitudinally-extending apex 20m. Right side surface 20j may be oriented at an angle of about 90° relative to right top surface 20d. Right side surface 20j may be oriented at an angle of about 135° relative to bottom surface 20b.

As shown in FIG. 4, each of the left side surface 20f and the right side surface 20j may extend for substantially the entire length of the shaft 20 that extends outwardly beyond first end 18a of handle 18. Bottom surface 20b may terminate a distance away from first end 18a in a transition region 20n.

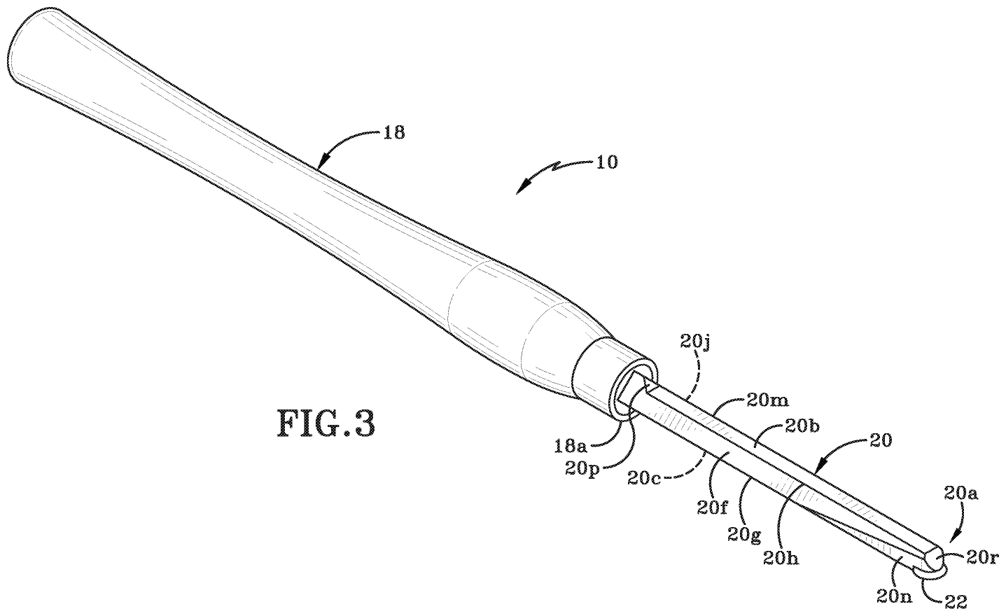

As shown in FIG. 2, a wedge-shaped region 20n may be provided proximate first end 20a of shaft and between each of the left and right top surfaces 20c, 30d, and bottom surface 20b. Region 20n may extend between lower portions of left and right top surfaces 20c, 20d, and bottom surface 20b and extend to first end 20a. Cutter 22 may be mounted on region 20n and an angled surface 20r (FIGS. 3 & 4) may extend downwardly from below cutter 22 to bottom surface 20b.

As shown in FIGS. 5, 7, and 8, the five-sided polygonal cross-sectional shape of the shaft 20 therefore comprises bottom surface 20b, left and right top surfaces 20c, 20d, and left and right side surfaces 20f, 20j; where the cross-section is oriented at right angles to the longitudinal axis “Y” of shaft 20.

While the angles between adjacent longitudinal surfaces of shaft 20 have been described above, it will be understood that shaft 20 may have the five-sided polygonal cross-sectional shape of a pentagon. In this instance, when the cross-sectional shape of a substantial length of shaft 20 is a pentagon, the angles between adjacent surfaces may be substantially equal i.e., in the order of around 108° relative to each other.

FIGS. 1 and 5 show tool 10 in a first position with bottom surface 20b resting on the top surface 12a of toolrest 12. Flat bottom surface 20b is able to be oriented parallel to the top surface 12a of toolrest 12 and substantially the entire width of bottom surface 20b from apex 20h to apex 20m is in abutting contact with top surface 12a of toolrest 12. As indicated earlier herein, this arrangement helps the craftsman to bring cutter 22 into contact with workpiece 16 in a controlled and stable manner. When tool 10 is used in the first position or first orientation, cutter 22 will cut away wood from workpiece 16 but the surface of the workpiece will be quite rough and will require sanding in order to make the interior surface bounding cavity 16a smooth.

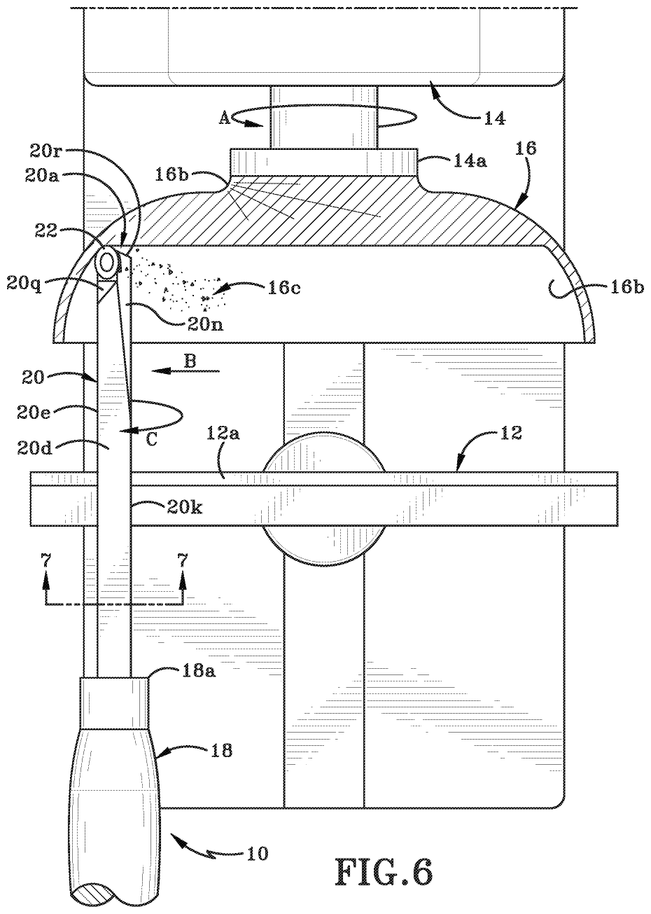

If the craftsman desires to change the orientation of cutter 22 relative to workpiece 16 he or she can rotate tool 10 in the direction indicated by arrow “C” in FIG. 6. This rotation from the first position (FIGS. 1 and 5) to a second position (FIGS. 6 and 7) moves bottom surface 20b of shaft 20 from abutting contact with top surface 12a of toolrest 12 and brings left side surface 20f into contact with top surface 12a of toolrest 12. As can be seen from FIG. 7, substantially the entire width of left side surface 20f from apex 20g to apex 20h is oriented parallel to and in abutting contact with top surface 12a of toolrest 12. So, even when tool 10 is in this second position, cutter 22 may be brought into contact with workpiece 16 in a controlled and stable manner.

FIG. 8 shows tool 10 in a third position that is the mirror image of the second position. In order to move tool 10 from the first position to the third position, tool 10 is rotated in the opposite direction to arrow “C” in FIG. 6. When tool 10 is moved into the third position, bottom surface 20b of shaft 20 is moved out of contact with top surface 12a of toolrest 12 and right side surface 20j is brought into contact with top surface 12a of toolrest 12. As can be seen from FIG. 8, substantially the entire width of right side surface 20j from apex 20e to apex 20k is oriented parallel to and in abutting contact with top surface 12a of toolrest 12. So, even when tool 10 is in this third position, cutter 22 may be brought into contact with workpiece 16 in a controlled and stable manner.

When tool 10 is brought into contact with top surface 12a of toolrest in the rotated second or third position (FIG. 7 or 8), it can be seen that bottom surface 20b is oriented at an angle of about 45° relative to top surface 12a. When tool 10 is in this orientation, it has been found that cutter 22 is oriented in such a manner that it leaves interior surface bounding cavity 16a substantially smooth enough that no additional sanding thereof is required.

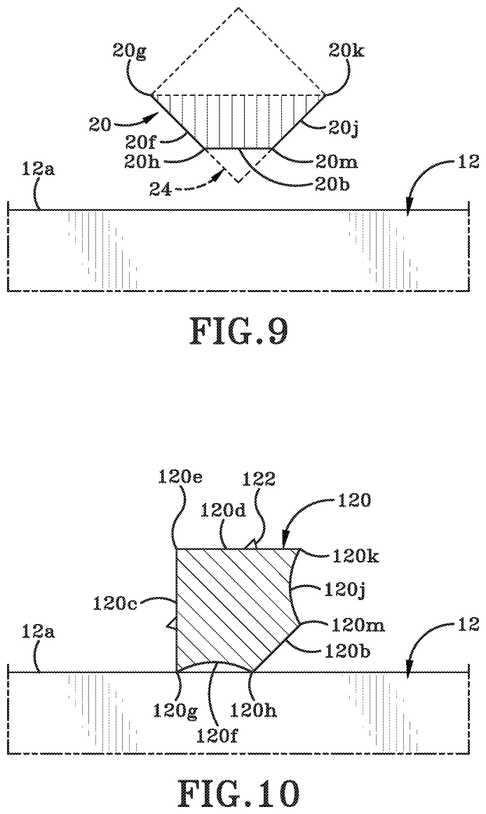

Shaft 20 includes a region having an exterior surface that is designed to be used to contact the top surface 12a of toolrest 12 of lathe 14 during use of tool 10. This exterior surface is oriented at right angles to longitudinal axis “Y”. The entire exterior surface does not contact top surface 12a simultaneously. Instead, portions of the exterior surface of this region are selectively brought into contact with top surface 12a by rotating shaft 20. FIG. 9 shows that the region of the shaft 20 that includes exterior surface is of a truncated-triangular shape and includes left side surface 20f, bottom surface 20b, right side surface 20j, and an imaginary line that extends from apex 20g to apex 20k. The triangle in question could include the truncated-triangular shape defined above plus an additional region 24 that is shown in phantom in FIG. 9. The region 24 is, however, removed.

It will be understood that in other examples of a wood turning tool in accordance with the present design the left and right side top surfaces 20c, 20d may be replaced with a single surface that extends between apex 20g and apex 20k. The single surface may be straight or it may be curved (concavely or concavely) between apex 20g and apex 20k. Alternatively more than two surfaces may be provided in the place of left and right side top surfaces 20c, 20d.

Left top surface 20c is flat across substantially the entire width thereof from apex 20g to apex 20e. Right top surface 20d is flat across substantially the entire width thereof from apex 20e to apex 20k. While it is not disclosed herein that shaft 20 may be rotated to bring either the left top surface 20c or the right top surface 20d into contact with top surface 12a of toolrest 12, should a craftsman desire to do so, he or she may utilize tool 10 in this manner in order to further change the orientation of cutter 22.

The system disclosed herein may be used in the following way. In a first step, the craftsman will secure a wooden workpiece 16 to a rotatable member 14a of a lathe 14. Lathe 14 will be actuated and this in turn will cause rotation of the rotatable member 14a about an axis. Rotation in rotatable member 14a will cause rotation of workpiece 16 in a same direction and in unison with rotatable member 14a. The craftsman may selected to apply woodturning tools to an exterior side surface of workpiece 16 to produce an overall exterior shape thereof. Alternatively, and as illustrated in FIGS. 1 and 6 herein, the craftsman may select to apply a woodturning tool, such as tool 10 to remove wood from an end of the workpiece 16.

Tool 10 may be of a type that is hand-held and is entirely guided by the craftsman's hands during shaping of the workpiece 16. The type of shaping illustrated in the attached figures is the hollowing out of an interior cavity 16a in workpiece 16. The craftsman may rest a flat bottom surface 20b of a shaft 20 of tool 10 on a top surface 12a of a toolrest 12 on lathe 14. (Top surface 12a may be flat or rounded and may be horizontally oriented, curved, or angled.) The craftsman will bring a cutter 22 on the first end of shaft 20 into contact with the wooden workpiece 16; removing wood shavings 16c from the wooden workpiece 16 with the cutter 22. When bottom surface 20b of shaft 20 is rested on top surface 12a of toolrest 12, then the cutter 22 is located in a first orientation, shown in FIGS. 1 and 5. Because workpiece 10 is being rotated by lathe 14, wood will be shaved, scraped, cut or otherwise removed from workpiece 10 by cutter being held in the first orientation. The step of removing of wood with the cutter 22 when in the first orientation includes producing a rough-cut surface in the workpiece 16. This type of surface requires additional sanding with sandpaper in order to produce a finished surface.

However, if tool 10 is rotated so that shaft 20 is rotated about the longitudinal axis “Y” and one of the left side surface 20f or right side surface 20j is brought into contact with top surface 12a of tool 12, then the orientation of cutter 22 is changed from the first orientation shown in FIG. 1 to the second orientation shown in FIG. 6; if the left side surface 20f contacts top surface 12a; or is changed from the first orientation shown in FIG. 1 to a third orientation that is a mirror image of the orientation shown in FIG. 6 if the right side surface 20j contacts top surface 12a. Rotation of the workpiece 16 continues and the craftsman will bring cutter 22 into contact with the workpiece once again to remove wood from the wooden workpiece 16. The step of removing of wood with the cutter 22 when the cutter is in the second orientation (or third orientation) includes producing a finished surface in the workpiece 16. The step of producing of the finished surface includes producing the finished surface with only the cutter 22 and without requiring additional sanding with sandpaper in order to attain the desired finished surface. It will be understood that sandpaper may still be utilized if desired but it typically is not necessary to use sandpaper in order to produce the finished surface.

FIG. 10 is a partial cross-sectional view showing a second embodiment of a shaft of the woodturning tool in accordance with the present disclosure, where the shaft is generally indicated by the reference number 120. Shaft 120 is substantially identical in structure and function to shaft 20 except for the features disclosed hereafter. Although not illustrated in FIG. 10, it will be understood that shaft 120 has a first end substantially identical to first end 20a. The first end of shaft 120 is located a distance outwardly beyond the first end of a handle (where the handle may be substantially identical or similar to handle 18). Shaft 120 has a second end that is embedded some distance within an interior bore of handle and will have a longitudinal axis that extends from the first end of the handle to the first end of the shaft 120. A cutter is selectively engaged with the first end of the shaft 120. The cutter may be substantially identical in structure and function to cutter 22.

Shaft 120 is fabricated so that substantially the entire length thereof has a cross-section that is configured generally as a five-sided polygon. Shaft 120 includes a bottom surface 120b (FIG. 10), a left top surface 120c and a right top surface 120d. Like bottom surface 20b, bottom surface 120b is flat and extends from a region proximate the first end of the handle to a region proximate the first end of shaft 120. Bottom surface 120b is provided so that shaft 120 may be rested in a first position (i.e., first orientation) upon at least a top surface 12a of the toolrest 12 of a lathe. The flat bottom surface 120b helps the craftsman to hold the first end of the shaft 120 and the cutter engaged therewith in a stable position relative to a workpiece, such the workpiece 16.

Shaft 120 further comprises a left top surface 120c and a right top surface 120d that are substantially identical in structure and function to left top surface 20c and right top surface 20d. Left and right top surfaces 120c, 120d extend longitudinally from the first end of the handle and towards the first end of shaft 120. Left and right top surfaces 120c, 120d meet along a longitudinally-extending apex 120e. Left and right top surfaces 120c, 120d may be oriented at angle of about 90° relative to each other.

Shaft 120 further comprises a left side surface 120f that originates proximate the first end of the handle and terminates proximate the first end of the shaft 120. The left side surface 120f is located between left top surface 120c and bottom surface 120b. Left side surface 120f is thus a surface that is adjacent to bottom surface 120b and to left top surface 120c. Left side surface 120f meets left top surface 120c along a longitudinally-extending apex 120g and meets bottom surface 120b along a longitudinally-extending apex 120h. Left side surface 120f differs in configuration from left side surface 20f. In particular, left side surface 120f is arcuate or curved while left side surface 20f (FIG. 7) is flat. Specifically, left side surface 120f is concave in shape. Consequently, if left side surface 120f is brought into contact with the top surface 12a of toolrest 12, there are only two contact points (or two contact regions) between shaft 120 and top surface 12a. Those two contact points or contact regions are the apex 120g and the apex 120h. FIG. 10 shows the apex 120g and the apex 120h being the only two points of contact or two regions of contact between shaft 120 and toolrest 12.

Shaft 120 further comprises a right side surface 120j. Like right side surface 20j, right side surface 120j originates proximate the first end of the handle and terminates proximate the first end of the shaft 120. Right side surface 120j is located between right top surface 120d and bottom surface 120b. Right side surface 120j is thus a surface that is adjacent to bottom surface 120b and adjacent to right top surface 120d. Right side surface 120j meets right top surface 120d along a longitudinally-extending apex 120k and meets bottom surface 120b along a longitudinally-extending apex 120m. Fight side surface 120j differs in configuration from right side surface 20j. In particular, right side surface 120j is arcuate or curved while right side surface 20j (FIG. 7) is flat. Specifically, right side surface 120j is concave in shape. Similar to left side surface 120f, if right side surface 120j is brought into contact with the top surface 12a of toolrest 12, there will only be two contact points between shaft 120 and top surface 12a. Those two contact points will be the apex 120k and the apex 120m.

It will be understood that a woodturning tool which includes shaft 120 will used in a substantially identical manner to woodturning tool 10.

It will further be understood that while shaft 120 is shown as including two concave surfaces, namely left side surface 120f and right side surface 120j, in other examples only one of the left side surface and the right side surface may be arcuate in configuration. The other of the left side surface and the right side surface may be flat (such as is illustrated in FIG. 7) or that surface may be convex in configuration.

In yet other examples, the bottom surface 120b may be arcuate in configuration. In particular, the bottom surface 120b may be concave in configuration. The curved bottom surface 120b will then present two contact points for contact with the top surface 12a of the toolrest 12. The two contact points will be the apex 120 and the apex 120m. In some examples, the bottom surface 120b may be the only curved surface on the woodturning tool. In other examples, the bottom surface 120b and only one of the left side surface 120f and right side surface 120j may be curved and the other of the left side surface 120f and right side surface 120j may be flat. In yet other examples, all of the bottom surface 120b, left side surface 120f and right side surface 120j will be curved, particular, concavely curved. In yet other examples, one or both of the left top surface 120c and right top surface 120d may, additionally or alternatively, be curved. In particular, one or both of the left top surface 120c or right top surface 120d may be concave in configuration or convex in configuration.

It will be understood that each of the left side surface 120f and the right side surface 120j may extend for substantially the entire length of the shaft 120 that extends outwardly beyond the first end of the handle of the woodturning tool. The bottom surface 120b may terminate a distance away from the first end of the handle in a wedge-shaped transition region that is substantially identical to transition region 20n. All other components of the woodturning tool that includes shaft 120 are substantially identical in structure and function to the components of the woodturning tool 10.

In one aspect, the present disclosure may therefore provide a woodturning tool comprising a handle; a shaft 120 extending outwardly from the handle (substantially identical to handle 18), said shaft 120 having a longitudinal axis; and a cutter (substantially identical to cutter 22) provided on an end of the shaft 120 a distance away from the handle. The shaft 120 includes a bottom surface 120b; a side surface 120f or 120j extending laterally outwardly from the bottom surface 120b; a top surface 120c or 120d extending laterally outwardly from the side surface 120f or 120j. One or more of the bottom surface 120b, the side surface 120f or 120j, and the top surface 120c or 120 presents two contact points for contacting a toolrest on a lathe. The two contact points presented by bottom surface 120b are apex 120h and apex 120m. The two contact points presented by the first side surface, i.e., left side surface 120f are apex 120g and apex 120h. The two contact points presented by the second side surface, i.e., right side surface 120j are apex 120m and apex 120m. If the top surface 120c is fabricated such that it is concavely configured and presents two contact points, those contact points will be apex 120e and apex 120g. If the top surface 120d is fabricated such that it is concavely shaped and presents two contact points, those contact points will be apex 120e and apex 120k.

In one aspect, the present disclosure may provide a system for shaping a workpiece comprising a lathe 14 including a chuck adapted to retain a workpiece 16 thereon; a toolrest 12 provided on the lathe 14; and a woodturning tool adapted to remove material from the workpiece 16. The woodturning tool comprises a handle (substantially identical to handle 18); a shaft 120 extending outwardly from the handle, said shaft 120 having a longitudinal axis (substantially identical to longitudinal axis “Y” (FIG. 4); and a cutter (substantially identical to cutter 22) 1provided on an end of the shaft 120 a distance away from the handle. The shaft 120 includes adjacent surfaces, such as surfaces 120b and 120f, or surfaces 120b and 120j, or surfaces 120f and 120c, or 120c and 120d, for example. The adjacent surfaces extend longitudinally along the shaft 120 from proximate the handle to proximate the end of the shaft that includes the cutter. Two contact points presented by one of the adjacent surfaces are selectively brought into contact with a surface 12a of the toolrest 12 when the woodturning tool is utilized during a woodturning operation. A woodturning operation may include the removal of wood from the workpiece 16 to create a finished product such as a bowl. The two contact points presented by bottom surface 120b are apex 120h and apex 120m. The two contact points presented by the first side surface, i.e., left side surface 120f are apex 120g and apex 120h. The two contact points presented by the second side surface, i.e., right side surface 120j are apex 120m and apex 120m. If the top surface 120c is fabricated such that it is concavely configured and presents two contact points, those contact points will be apex 120e and apex 120g. If the top surface 120d is fabricated such that it is concavely shaped and presents two contact points, those contact points will be apex 120e and apex 120k.

In one aspect, the present disclosure may provide a method of shaping a wooden workpiece 16 comprising securing a wooden workpiece 16 to a rotatable member of a lathe 14; rotating the rotatable member about an axis (such as in the direction “A” shown in FIG. 1); providing a woodturning tool having a handle (substantially identical to handle 18) and a shaft 120. The shaft 120 includes adjacent surfaces, such as surfaces 120b and 120f, or surfaces 120b and 120j, or surfaces 120f and 120c, or 120c and 120d, for example. The adjacent surfaces extend from proximate the handle to proximate an end of the shaft; orienting a cutter (substantially identical to cutter 22) on the end of the shaft in a first orientation by selectively resting two spaced-apart contact points on one of the adjacent surfaces on a top surface 12a of a toolrest 12 on the lathe 14. The two contact points presented by bottom surface 120b are apex 120h and apex 120m. The two contact points presented by the first side surface, i.e., left side surface 120f are apex 120g and apex 120h. The two contact points presented by the second side surface, i.e., right side surface 120j are apex 120m and apex 120m. If the top surface 120c is fabricated such that it is concavely configured and presents two contact points, those contact points will be apex 120e and apex 120g. If the top surface 120d is fabricated such that it is concavely shaped and presents two contact points, those contact points will be apex 120e and apex 120k.

The method further includes bringing the cutter into contact with the wooden workpiece 16; and removing wood from the wooden workpiece 16 with the cutter, when the cutter is in the first orientation. The method further comprises rotating the shaft 120 of the woodturning tool to position the cutter in a second orientation by placing another of the adjacent surfaces of the shaft 120 in contact with the top surface 12a of the toolrest 12; and removing wood from the wooden workpiece 16 with the cutter, when the cutter is located in a second orientation. The removing of wood with the cutter when the cutter is in the first orientation includes producing a rough-cut surface in the workpiece 16. The removing of wood with the cutter when the cutter is in the second orientation includes producing a finished surface in the workpiece 16 with the cutter and without requiring additional sanding to produce the finished surface.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of value and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, any method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases.

In the foregoing description, certain terms have been used for brevity, clarity, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed:

1. A woodturning tool comprising:
a handle;
a shaft extending outwardly from the handle, said shaft having a longitudinal axis; and
a cutter provided on an end of the shaft a distance away from the handle;
wherein the shaft includes:
a bottom surface;
a side surface extending laterally outwardly from the bottom surface;
wherein one or more of the bottom surface and the side surface presents two contact points for contacting a toolrest on a lathe.

2. The woodturning tool defined in claim 1, further comprising a top surface extending laterally outwardly from the side surface; and wherein one or more of the bottom surface, the side surface, and the top surface present two contact points for contacting the toolrest on the lathe.

3. The woodturning tool defined in claim 2, wherein the one of more of the bottom surface, the side surface, and the top surface is curved.

4. The woodturning tool defined in claim 3, wherein the one or more of the bottom surface, the side surface, and the top surface is concave.

5. The woodturning tool defined in claim 1, wherein a first contact point of the two contact points is an apex where the bottom surface intersects the side surface.

6. The woodturning tool as defined in claim 2, wherein a first contact point of the two contact points is an apex where the side surface intersects the top surface.

7. The woodturning tool as defined in claim 2, wherein a first contact point of the two contact points is an apex where the bottom surface intersects the side surface, and a second contact points of the two contact points is an apex where the side surface intersects the top surface.

8. A woodturning tool comprising:
a handle;
a shaft extending outwardly from the handle, said shaft having a longitudinal axis; and
a cutter provided on an end of the shaft a distance away from the handle;
wherein the shaft includes a bottom surface and a first side surface; wherein each of the bottom surface and the first side surface is adapted to be separately brought into contact with a toolrest on a lathe; and wherein at least one of the bottom surface and the first side surface presents two spaced apart contact regions that are adapted to be brought into contact with a surface of a toolrest on a lathe.

9. The woodturning tool defined in claim 8, wherein the shaft further includes a second side surface that extends outwardly from the bottom surface in an opposite direction to the first side surface; and wherein one or more of the bottom surface, the first side surface and the second side surface presents the two spaced apart contact regions that are adapted to be brought into contact with the surface of the toolrest on the lathe.

10. The woodturning tool defined in claim 9, wherein each of the first side surface and the second side surface originates proximate the handle and extends to the end of the shaft that includes the cutter.

11. The woodturning tool defined in claim 8, wherein the bottom surface originates a distance forwardly from the handle and terminates a distance inwardly from the cutter.

12. The woodturning tool defined in claim 11, wherein the shaft further comprises a generally wedge-shaped transition region interposed between a front end of the bottom surface and the cutter.

13. The woodturning tool defined in claim 9, wherein the shaft is a five-sided polygon in cross-section; and further includes a left top surface and a right top surface; wherein the left top surface extends outwardly from the first side surface; and the right top surface extends outwardly from the second side surface; and the left top surface and right top surface meet along a longitudinally extending apex.

14. A system for shaping a workpiece comprising:
a lathe including a chuck adapted to retain a workpiece thereon;
a toolrest provided on the lathe; and
a woodturning tool adapted to remove material from the workpiece, wherein said woodturning tool comprises:
a handle;
a shaft extending outwardly from the handle, said shaft having a longitudinal axis; and
a cutter provided on an end of the shaft a distance away from the handle;
wherein the shaft includes adjacent surfaces that extend longitudinally along the shaft from proximate the handle to proximate the end of the shaft that includes the cutter; and
wherein two contact points presented by one of the adjacent surfaces are selectively brought into contact with a surface of the toolrest when the woodturning tool is utilized during a woodturning operation.

15. The system as defined in claim 14, wherein the one of the adjacent surfaces is curved.

16. The system as defined in claim 15, wherein the one of the adjacent surfaces is concave in curvature.

17. The system as defined in claim 14, wherein each of the two contact points is located where the adjacent surfaces intersect each other.

18. The system as defined in claim 14, wherein the adjacent surfaces include a bottom surface, a side surface, and a top surface that extend longitudinally along the shaft from proximate the handle to proximate the end of the shaft that includes the cutter; and wherein the side surface extends laterally between the bottom surface and the top surface.

19. The system as defined in claim 18, wherein the shaft is a five-sided polygon in cross-section and includes five longitudinally extending surfaces that form an exterior surface of the shaft; and wherein the bottom surface and side surface comprise two sides of the five-sided polygon.

20. A method of shaping a wooden workpiece comprising:
securing a wooden workpiece to a rotatable member of a lathe;
rotating the rotatable member about an axis;
providing a woodturning tool having a handle and a shaft; where the shaft includes adjacent surfaces extending from proximate the handle to proximate an end of the shaft;
orienting a cutter on the end of the shaft in a first orientation by selectively resting two spaced-apart contact points on one of the adjacent surfaces on a top surface of a toolrest on the lathe;
bringing the cutter into contact with the wooden workpiece; and
removing wood from the wooden workpiece with the cutter, when the cutter is in the first orientation.

21. The method as defined in claim 20, further comprising:
rotating the shaft of the woodturning tool to position the cutter in a second orientation by placing another of the adjacent surfaces of the shaft in contact with the top surface of the toolrest; and
removing wood from the wooden workpiece with the cutter, when the cutter is located in a second orientation.

22. The method as defined in claim 21, wherein the removing of wood with the cutter when the cutter is in the first orientation includes producing a rough-cut surface in the workpiece.

23. The method as defined in claim 22, wherein the removing of wood with the cutter when the cutter is in the second orientation includes producing a finished surface in the workpiece with the cutter and without requiring additional sanding to produce the finished surface.
